(19) United States
(12) Patent Application Publication
(10) Pub. No.: US 2008/0260327 A1
(43) Pub. Date: Oct. 23, 2008

(54) INTEGRATED CIRCUIT HAVING COMPACT HIGH-SPEED BUS LINES FOR OPTICAL SIGNAL

(76) Inventors: Hung-Huei Liao, Yang-Mei (TW); Chong-Long Ho, Yang-Mei (TW)

Correspondence Address: SINORICA, LLC, 528 FALLSGROVE DRIVE, ROCKVILLE, MD, 20850, US

(21) Appl. No.: 11/736,083

(22) Filed: Apr. 17, 2007

(51) Int. Cl. G02B 6/12

(52) U.S. Cl. 385/14

(57) ABSTRACT

An integrated circuit having compact high-speed bus lines consists of VCSEL Array providing optical fiber holes, PIN Array providing optical fiber holes, and multi-mode optical fiber with great diameter optical core, wherein the VCSEL Array providing optical fiber holes and the PIN Array providing optical fiber holes both utilize the microelectromechanical system (MEMC) technology to form optical fiber holes as a concentric cylinder shape with diameter 100 μm, height 30 μm and diameter 130 μm, height 80-100 μm in the VCSEL light emitting area and the PIN light receiving area, respectively. An integrated package can be easily accomplished by mechanically performing focusing package of fixed optic-insertion to complete a glued integrated package, and thereby the package cost as a majority of the prime cost can be greatly reduced.

### BACKGROUND OF THE INVENTION

1. Field of the Invention

The present invention is related to an integrated circuit having compact high-speed bus lines for optical signals to be used in ultra-speed electronic circuit boards and its interface connections. The present invention is adaptable for different electric connectors and used for optical signal transmissions between interface ICs of high-speed routers and switches for linking up a high-speed bus.

2. Description of the Prior Art

Due to strong demand of high-speed broadband, a design of preventing interferences incurred by transmitting broadband signals between high-density copper wires has become difficult. The existing apparatuses for optical signal interconnecting are complex and cause high manufacturing cost than average electronic products, thus which cannot be efficiently utilized. Most of the short distance optical signal connections that employed point-to-point optical interface connections which is difficult in manufacturing an ultra-compact bus line, especially, is even harder for optical fiber package in connection with LD Array and PIN Array.

In view of the above, an integrated circuit with high-speed bus lines for optical signals of the present invention that provides advantages like compact volume, low manufacturing cost, simplified manufacturing process, and easy to use is disclosed. It is a fiber hole array that primarily consists of fiber holes, a Vertical Cavity Surface Emitting Laser Array (VCSEL Array), and a PIN Array, for solving a technical bottleneck concerning optical-fiber package so as to increase product yield and reduce the manufacturing cost. Therefore, a great amount of the high-speed optical signal bus lines can be manufactured in a simple way, accordingly, and the single-mode fiber having tiny fiber core can thus be unobstructed. Such the high-speed optical signal bus line also prevents mutual interferences between an ultra-speed electronic circuit board and its related interfaces as proceeding parallel transmission, and avoids noise radiated interferences derived from impedance mismatch as high frequency transmission occurred on a circuit board. The transmission of high-speed signals can be prevented from an interference caused by components on a high frequency circuit board.

The optical communication was first applied to long distance transmissions. However, optical fibers have been commonly used to link a server with a router or a switch that is only meters away. It is expected to use optoelectronic components in a way as easy as IC chips being used in a circuit board. However, the fabrication of optical component is much more difficult than that of IC chips. The medium variation of material is quite different to be integrated as fabricating optoelectronic components. Also, positioning optical waveguides and other optical transmitting paths have to be calibrated within a range of 1*m. It still requires manual operation and thus cannot be produced in a great number, resulting relatively high cost. Some companies have presented prototypes such as 1) the VCSEL prototype with 850 nm band produced by Fuji Xerox, 2) the VCSEL prototype with 1300 nm band produced by NEC that integrated all the optoelectronic components in a circuit board with BGA package, 3) the optic-interconnection silicon substrate prototype presented by OKI, 4) the integrated circuit with optical I/O interface, presented by NTT, and the products having devices identical with those used in electronic components, and 5) manufactured by US Peregrine Semiconductor Corp., a module with 10 Gbps optical transceiver built on a sapphire substrate. Those prototypes developed by the above-mentioned companies are difficult to manufacture, and are expensive and devoid of flexibility.

Therefore, the above conventional manners involving with disadvantages cannot thus be considered as an ideal design and should be improved.

In view of the defects derived from the above convention, the inventor of the present invention has given every effort in reformation and innovation. After years of painstaking efforts, the integrated circuit with high-speed optical signal bus lines of the present invention is successfully developed. The integrated circuit with high-speed bus lines for optical signals brings low cost and convenient usages for solving the issues of high producing cost caused by device complexity and complicated manufacturing process, such that optoelectronic components can be employed as easy as using IC chip on a circuit board.

### SUMMARY OF THE INVENTION

A primary objective of the present invention is to provide an integrated circuit having compact high-speed bus lines for optical signals which is low cost and ease of use.

A secondary objective of the present invention is to provide an integrated circuit having compact high-speed bus lines for optical signals that is capable of solving disadvantages such as highly complicated structure and high cost due to processes difficulties, rendering that the use of optoelectronic components would be easy as using an IC chip in a circuit board.

Another objective of the present invention is to provide an integrated circuit having compact high-speed bus lines for optical signals for ease of use in ultra-speed circuit board and related interface connections, solving the limitation of laying ultra-speed transmission wires in the circuit board having high-density layout.

A further objective of the present invention is to provide a compact high-speed optical bus line for use in a rotatable cover of the cell phones (instead of present flexible circuit board) and of the notebooks.

To achieve the above objectives, an integrated circuit having compact high-speed optical signal bus lines of the present invention uses a fiber hole array for solving the technical bottlenecks concerning optical-fiber package of array wafer for increasing productions and reducing manufacturing cost. Therefore, the integrated circuit with interconnection buses for optical signals can be produced in a simplified way, mainly comprising:

VCSEL Array with fiber holes;

PIN Array with fiber holes; and

multi-mode optical fiber with great diameter of optical core.

### BRIEF DESCRIPTION OF THE DRAWINGS

The drawings disclose an illustrative embodiment of the present invention which serves to exemplify the various advantages and objectives hereof, and are as follows:

FIG. 1 is a disassembled integrated circuit having compact high-speed optical signal bus lines of the present invention;

FIG. 2 is an integral configuration of the integrated circuit having compact high-speed optical signal bus lines;

FIG. 3 is a schematic diagram illustrating an embodiment of applying the integrated circuit having compact high-speed optical signal bus lines to an circuit-free ultra-speed optical signal interconnection bus; and

FIG. 4 is an IC package diagram illustrating an application of the integrated circuit having compact high-speed optical signal bus lines in a RF circuit board.

### DETAILED DESCRIPTION OF THE PREFERRED EMBODIMENT

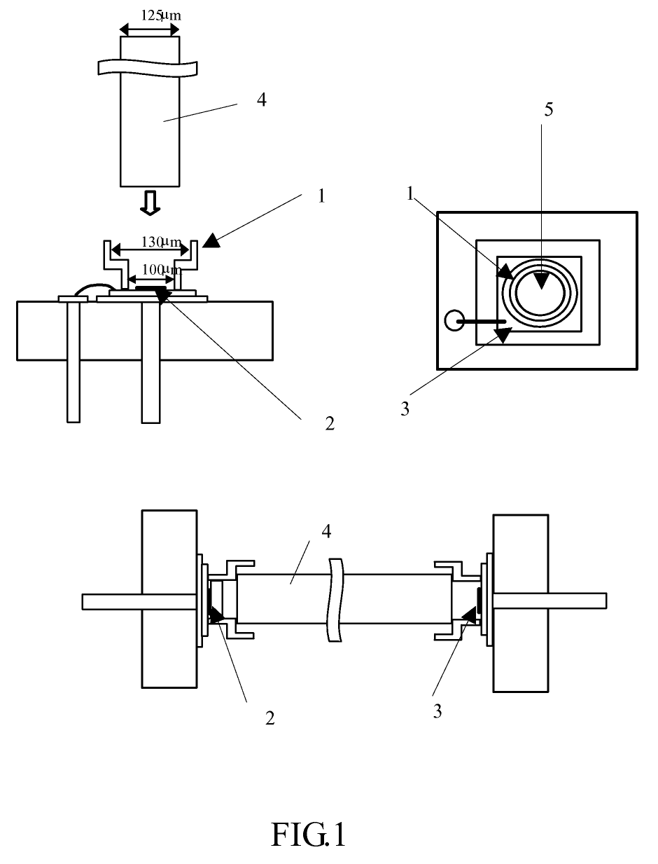

Referring to FIG. 1 and taking one of the wafers in the array as example, the integrated circuit having compact high-speed optical signal bus lines of the present invention comprises:

a Multi-mode optical fiber, in which two ends of the multi-mode optical fiber are placed in the fiber holes 1, respectively;

a Vertical Cavity Surface Emitting Laser Array (VCSEL Array) 2 with the fiber holes 1 in which the light source for VCSEL Array 2 can be LED or other surface emitting lasers;

a PIN Array 3 with the fiber holes 1 wherein the material of PIN Array is silicon; and

a Multi-mode optical fiber 4 with optical core having great diameter.

Referring to VCSEL Array 2 that has the fiber holes 1 and PIN Array 3 having the fiber holes 1 wherein the fiber holes 1 are formed in VCSEL light emitting area/PIN light receiving area 5, respectively, by microelectromechanical system (MEMC) technology as a concentric cylinder shape with diameter 100 μm, height 30 μm and diameter 130 μm, height 80-100 μm. An integrated package can be easily produced by mechanically performing focus package of optic-insertion to be glued such that the package cost can be greatly reduced.

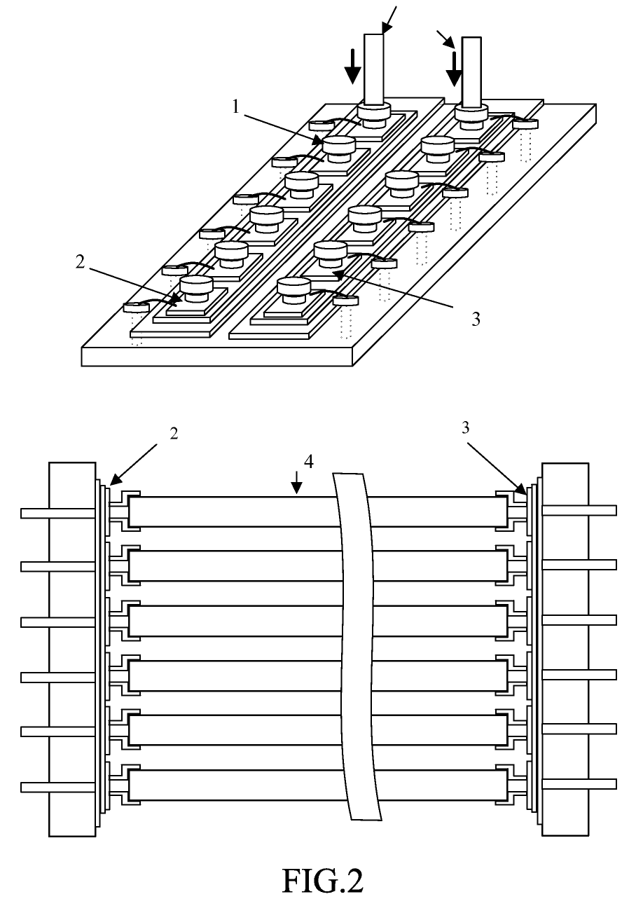

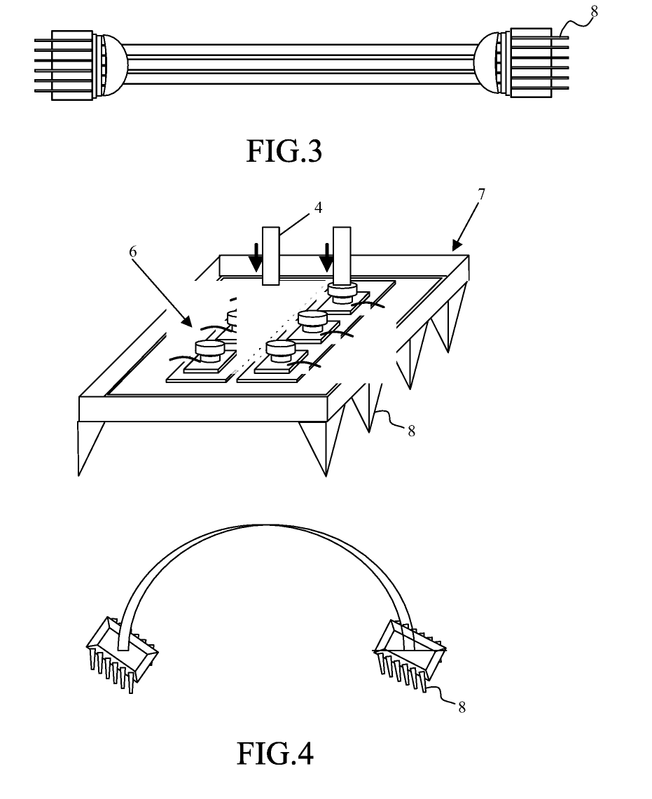

Further, referring to FIG. 2, the multi-mode optical fiber having great diameter optical core is mainly used to couple to VCSEL Array 2 and PIN Array 3. Since the connecting distance is so short (less than 1 m), the loss in light transmission and dispersion will not be an issue, and also the intension requirement of light power is trivia. In order to reduce the cost for light positioning focused package, the diameter of the fiber core of the multi-mode optical fiber 4 can be raised in order to increase its tolerance of light coupling. With VCSEL light source providing a tiny divergent angle and PIN package, fixing focused package performed mechanically is merely required. Referring to FIG. 3, the pin of VCSEL Array 2 may directly connect to a laser driver and the pin of PIN Array 3 may directly connect to a post amplifier in which the pin can be configured to fit for various pin adapters for different frequencies. Since the integrated circuit having compact high-speed optical signal bus lines of the present invention merely utilizes electronic connectors for making electric connections, it is easy for circuit board manufacturers to use them. In addition, it is convenient to adjust the length of the optical fiber, and the cost is lower than that of the high frequency transmission jumper wire. Furthermore, based on multiple channels, the integrated circuit having compact high-speed optical signal bus lines of the present invention is made as a bus line, providing a utilization similar to an ordinary electric bus line, that provides the required features, smaller sizes, not being mutually interfered, and being flexible. The integrated circuit having compact high-speed optical signal bus lines of the present invention can be soldered with the pin of the IC 7 directly or connected to the RF circuit board 6 as a product of an integrated circuit providing optical signal interconnection bus as shown in FIG. 4. Moreover, the multi-mode optical fibers 4 can be unlimitedly coiled with approximately zero power loss, and which makes the integrated circuit having compact high-speed optical signal bus lines of the present invention to have the required features, smaller sizes, low cost, easy to assemble, and immune from electromagnetic interference, and does not have to ground, match impedance, avoid crosstalk, especially.

In comparison with conventional techniques, the integrated circuit having compact high-speed optical signal bus lines of the present invention further provides advantages as follows:

1. The optoelectronic components of the present invention can be used as easy as IC chips being used in a circuit board.

2. The present invention is low manufacturing cost and small to be easily utilized as an integrated circuit having optic-connection bus lines.

3. The present invention is capable of employing various electric adapters for interconnecting with the optical signals of the interface IC of current high-speed routers and switches.

4. The product yield of the present invention is high, and the present invention is simple, flexible (multi-mode optical fibers can be unlimitedly coiled with approximately zero power loss), and free for direction changing but does not involve with a defect like phase differential due to direction changing of high-speed signals and dedication decline.

The above detailed description is used to elaborate one achievable embodiment of the present invention rather than restrict the scope of the claims of the subject application. Any equivalent embodiment or modification that does not go beyond the concept of the present invention should be deemed as included in the claims of the subject application.

To sum up, the present invention is not only novel in technical conception but also provides advantages that prior art does not offer. The present invention complies with the statutory requirements in connection with novelty and non-obviousness for an invention patent and, by the related regulations, files a patent application. The applicant respectfully hopes that a grant of this patent application would be ratified.

Many changes and modification in the above described embodiment of the invention can, of course, be carried out without departing from the scope thereof. Accordingly, to promote the progress in science and the useful arts, the invention is disclosed and is intended to be limited only by the scope of the appended claims.

1. An integrated circuit having compact high-speed optical-signal bus lines that employs optical fiber hole arrays to solve a technical bottleneck concerning optical-fiber package of array wafer for increasing the product yield and reducing the manufacturing cost so as to fabricate the integrated circuit having bus lines for optical-signal in a simple way, comprises:
a multi-mode optical fiber whose two ends are disposed into optical fiber holes, respectively;
a VCSEL array that couples with the optical fiber holes;
a PIN array that couples with another fiber hole; and
the multi-mode optical fiber has an optical cores with a diameter of 100 micron-meter (μm).

2. The integrated circuit having compact high-speed optical-signal bus lines of claim 1, wherein the optical fiber holes are with concentric cylinder shape and formed by utilizing microelectromechanical system (MEMC) technology and accomplished by mechanically performing focusing package of fixed optic-insertion to complete a glued integrated package.

3. The integrated circuit having compact high-speed optical-signal bus lines of claim 1, wherein the light source for the VCSEL array is LED or other surface emitting lasers.

4. (canceled)

5. The integrated circuit having compact high-speed optical-signal bus lines of claim 1, wherein the electric pins of the VCSEL array directly connect to a laser driver and the electric pins of the PIN array directly connect to a post amplifier.

6. The integrated circuit having compact high-speed optical-signal bus lines of claim 5, wherein the electric pins are adaptable to have different interface types of electric connector upon different frequencies.
